(19) United States
(12) Patent Application Publication
(10) Pub. No.: US 2025/0117832 A1
(43) Pub. Date: Apr. 10, 2025

(54) METHOD AND SYSTEM FOR MANAGING COMPUTING RESOURCES FOR TRANSFERRING ELECTRONIC DATA

(71) Applicant: LAWVO INC., North York (CA)

(72) Inventors: Fernand VARTANIAN, North York (CA); Lena VARTANIAN, North York (CA); Hosep SARAYDRIAN, Markham (CA)

(21) Appl. No.: 18/838,189

(22) PCT Filed: Apr. 12, 2023
(86) PCT No.: PCT/IB2023/053756

§ 371 Date: Aug. 13, 2024

Related U.S. Application Data
(60) Provisional application No. 63/330,881, filed on Apr. 14, 2022.

(51) Int. Cl. G06Q 30/0282; G06Q 30/0283; G06Q 50/18

(52) U.S. Cl. CPC G06Q 30/0282; G06Q 50/18; G06Q 30/0283

(57) ABSTRACT

The present disclosure includes a system for generating and distributing data records representing quotes for legal services. The data records are generated at a server in response to a request from a client device. The data records are based on parameters received from a plurality of platforms, the parameters representing estimated costs for providing services. The server determines a subset of data records to transmit to the client device based on the parameters, the request, and a rating.

### CROSS-REFERENCE TO RELATED APPLICATION(S)

This application claims the benefit of U.S. Provisional Patent Application No. 63/330,881, filed Apr. 14, 2022, entitled “METHOD AND SYSTEM FOR MANAGING ELECTRONIC DATA REPRESENTING QUOTES FOR LEGAL SERVICES”; the entire contents of which are incorporated herein by reference.

### FIELD

The present specification is directed to computer networking communications and more specifically computer networking involving the management of computing resources for transferring electronic data.

### BACKGROUND

Professional services are increasingly offered via the Internet. Typically, a client locates a service provider through keyword searching using a search engine. Regrettably, keyword searching is known to return irrelevant results which wastes computing resources on the server, unnecessarily consumes network bandwidth, and consumes local processing, memory, and display resources on the client device. This results in an overall waste of computing and network resources. The problem can be exacerbated by paid advertising and sponsored search results.

### SUMMARY

It is an aspect of the present disclosure to provide a method for managing data records representing quotes.

The above aspect can be attained by receiving an electronic request at a server from a client device via a primary platform. In response, secondary platform parameters are retrieved from memory at the server. Each secondary platform parameter is associated with one of a plurality of secondary platforms. A rating for each secondary platform parameter is further retrieved from memory at the server. Each rating represents a quality of a match between a primary workflow respective to the primary platform and a secondary workflow that complements the primary workflow, and which is hosted by each of the secondary platforms. A subset of the secondary platforms is determined based on the secondary platform parameters, the electronic request, and the ratings. The client device is controlled to generate the subset of the secondary platforms. A selection response that corresponds to a selected one of the subset of secondary platforms is received from the client device.

The ratings may be updated based on the selection response.

The electronic request may include primary request parameters and secondary request parameters. In response to receiving the electronic request, the server controls the client device based on the primary request parameters and the secondary request parameters.

The subset of the secondary platforms may be determined by generating a data record for each of the plurality of secondary platforms and computing a competitiveness score based on at least one of: the respective secondary parameters, the respective ratings, and the respective data records. The subset of secondary platforms is selected based on the competitiveness score.

An intake workflow may be implemented by controlling the client device, the primary platform, and the selected secondary platform. A production workflow is implemented by controlling the client device, the primary platform, and the selected secondary platform.

A further selection response may be received from the client device. The further selection corresponds to another one of the plurality of secondary platforms. In response to receiving the further selection response, the intake and production workflows are updated accordingly.

The data records may be updated based on the competitiveness score.

It is a further aspect of the disclosure to provide a method for managing data records representing quotes.

The above aspect can be attained by receiving an electronic request at a server from a client device. In response to the electronic request, platform parameters are retrieved from memory at the server. Each platform parameter is associated with one of a plurality of platforms. A data record is generated for each of the plurality of platforms and a competitiveness score is computed for each of the data records. Based on the respective competitiveness scores, the data records are further updated. A subset of the platforms is determined based on the platform parameters, the electronic request, and the competitiveness score. The client device is controlled based on the subset of platforms. A selection response is received from the client device, the selection response corresponding to a selected one of the subset of platforms.

The competitiveness score may be based on at least one of: the respective secondary parameters, the respective ratings, and the respective data records.

The client device and the platform may be controlled to implement an intake workflow and a production workflow.

A further selection response corresponding to another one of the plurality of platforms may be received from the client device. In response, the intake and production workflows may be updated accordingly.

It is a further aspect of the disclosure to provide a system for managing data records representing quotes. The system includes a client device, a primary platform, a plurality of secondary platforms, and a server. The client device is configured to transmit an electronic request via the primary platform. The plurality of secondary platforms is configured to transmit secondary platform parameters to the server. The server is configured to receive the electronic request and retrieve the secondary platform parameters from memory. Each secondary platform parameter is associated with one of a plurality of secondary platforms. The server is further configured to retrieve a rating from memory for each secondary platform parameter. The ratings represent a quality of a match between a primary workflow respective to the primary platform and a secondary workflow that complements the primary workflow and which is hosted by each of the secondary platforms. The server is further configured to determine a subset of the secondary platforms based on the secondary platform parameters, the electronic request, and the ratings. The server is configured to control the client device to generate the subset of the secondary platforms based on the ratings and receive a selection response from the client device, the selection response corresponding to a selected one of the subset of secondary platforms.

The server may be further configured to update the ratings based on the selection response.

The server may be further configured to receive primary and secondary request parameters from the client device and control the client device based on the primary and secondary request parameters.

The server may be further configured to generate a data record and competitiveness score for each of the plurality of secondary platforms. The competitiveness score is based on at least one of: the respective secondary parameters, the respective ratings, and the respective data records. The server uses the competitiveness score to select the subset of secondary platforms.

The server may be configured to control the client device, the primary platform, and the selected secondary platform to implement an intake workflow and a production workflow.

The client device may be configured to transmit a further selection response to the server, the further selection corresponding to another one of the plurality of secondary platforms. In response to receive the further selection response, the server is configured to update the intake and production workflows accordingly.

The server may be further configured to update the data records based on the competitiveness score.

It is a further aspect of the disclosure to provide a system for managing data records representing quotes.

The above aspect can be attained by a system that includes a server, a client device for transmitting an electronic request to the server, and a plurality of platforms for transmitting platform parameters to the server. The server is configured to receive the electronic request from the client device, and in response, retrieve the platform parameters from memory. Each platform parameter is associated with one of a plurality of platforms. For each of the plurality of platforms, the server generates a data record for each of the plurality of platforms based on the platform parameters and the electronic request. For each of the data records, the server further computes a competitiveness score. Based on the competitiveness score, the server updates the data records. According to the platform parameters, the electronic request, and the competitiveness score, the server determines a subset of the platforms and controls the client device based on the subset of platforms. The server is configured to receive a selection response corresponding to one of the subset of platforms.

The server may be further configured to compute a competitiveness score based on at least one of: the respective secondary parameters, the respective ratings, and the respective data records.

The server may be further configured to control the client device and the platform to implement an intake workflow and a production workflow.

The client device may be further configured to transmit a further selection response which corresponds to another one of the plurality of platforms. In response to receiving the further selection response, the server is further configured to update the intake and production workflows.

It is another aspect of the disclosure to provide a non-transitory computer readable medium comprising instructions for managing data records representing quotes.

The above aspect can be attained by a non-transitory computer readable medium including instructions for receiving an electronic request at a server from a client device via a primary platform. The instructions further include retrieving secondary platform parameters from memory at the server. Each secondary platform parameter is associated with one of a plurality of secondary platforms. The instructions further include retrieving a rating from memory for each secondary platform parameter. The ratings represent a quality of a match between a primary workflow respective to the primary platform and a secondary workflow that complements the primary workflow and which is hosted by each of the secondary platforms. The instructions further include determining a subset of the secondary platforms based on the secondary platform parameters, the electronic request, and the ratings. The instructions are further for controlling the client device to generate the subset of secondary platform and receiving a selection response from the client device. The selection response corresponds to a selected one of the subset of secondary platforms.

The instructions may further include updating the ratings based on the selection response.

Receiving the electronic request may include receiving primary and secondary request parameters. The instructions may include controlling the client device based on the primary and secondary request parameters.

Determining the subset of the secondary platforms may include, generating a data record for each of the plurality of secondary platforms and computing a competitiveness score based on at least one of: the respective secondary parameters, the respective ratings, and the respective data records. The instructions may further include selecting the subset of secondary platforms based on the competitiveness score.

The instructions may further include controlling the client device, the primary platform, and the selected secondary platform to implement an intake workflow and a production workflow.

The instructions may further include receiving a further selection response corresponding to another one of the plurality of secondary platforms and updating the intake and production workflows accordingly.

The instructions may further include updating the data records based on the competitiveness score.

It is a further aspect of the disclosure to provide a non-transitory computer readable medium for managing data records representing quotes.

The above aspect can be attained by providing a non-transitory computer readable medium including instructions for receiving an electronic request at a server from a client device, and in response, retrieving platform parameters from memory. Each platform parameter is associated with one of a plurality of platforms. For each of the plurality of platforms, the instructions further include generating a data record and computing a competitiveness score for each of the data records. The data records are updated based on the respective competitiveness scores. Based on the platform parameters, the electronic request, and the competitiveness score, a subset of the platform parameters is determined. The instructions further include controlling the client device based on the subset of platforms. A selection response is received from the client device, the selection response corresponding to one of the subset of platforms.

Computing a competitiveness score may be based on at least one of: the respective secondary parameters, the respective ratings, and the respective data records.

The instructions may further include controlling the client device, and the platform to implement an intake workflow and a production workflow.

The instructions may further include receiving a further selection response from the client device which corresponds to another one of the plurality of platforms. According to the further selection response, the intake and production workflows are updated.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a schematic diagram showing a system for managing data records representing quotes for legal services including a server.

FIG. 2 is a schematic diagram of example internal components of the server of FIG. 1.

FIG. 3 is a flowchart depicting a method for managing data records in accordance with one embodiment.

FIG. 4 is a flowchart depicting exemplary performance of block 304 of the method of FIG. 3.

FIG. 5 is a flowchart depicting exemplary performance of block 316 of the method of FIG. 3.

FIG. 6 is a flowchart depicting exemplary performance of an example use case of the method of FIG. 3.

FIG. 7 is a flowchart depicting another method for managing data records in accordance with a further embodiment.

FIG. 8 is flowchart depicting exemplary performance of block 316a of the method of FIG. 7.

### DETAILED DESCRIPTION

The present disclosure pertains to a system for managing and distributing electronic parameters for legal services. According to certain aspects of the disclosure, the parameters can be retrieved at a server in response to a request received from a client device. The parameters can be received from a plurality of platforms, the parameters representing estimated costs for providing the legal service indicated in the request. The server can select a subsection of the parameters and control the client device to display the subset. In response, the server receives a selection from the client device which can include a rating for the selection.

The methods, functionality, and other techniques discussed herein may be carried out by instructions, which may be directly executable (e.g., a binary file), indirectly executable (e.g., bytecode), interpreted (e.g., a script), or otherwise executable by a processor. Instructions may be stored in a non-transitory computer-readable medium, such as a memory, hard drive, or similar device.

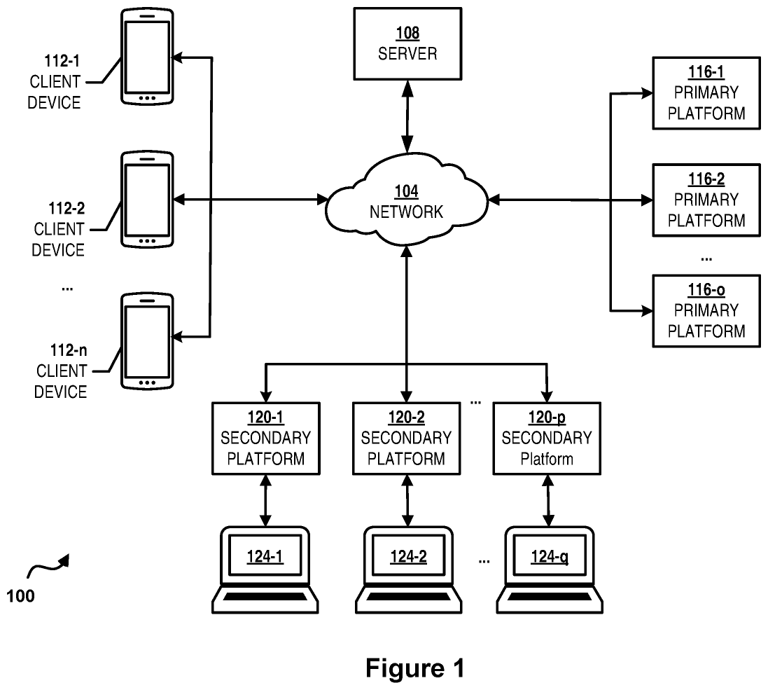

Referring now to FIG. 1, a system for managing data records is indicated generally at 100. System 100 comprises a network 104 connected to a server 108 and further connected to a plurality of client devices 112-1, 112-2 . . . 112-n (generically referred to herein as “client device 112” or collectively as “client devices 112”. This nomenclature is used elsewhere herein). System 100 further includes a plurality of primary platforms 116 and a plurality of secondary platforms 120. Network 104 is further connected to server 108.

Server 108 is typically a server or mainframe with a housing containing an arrangement of one or more central processing units, volatile memory (i.e., random access memory), persistent or non-volatile memory (i.e., hard disk devices) and a network interface (to allow server 108 to communicate over network 104) all of which are interconnected by a bus. In some embodiments, server 108 is a virtual server. As explained in detail below, server 108 is configured to receive parameters from client devices 112 via network 104 and is further configured to transmit data messages or records representing quotes to client devices 112 via network 104.

Network 104 can be wired or wireless, or based on combinations thereof, and based on any type of known network architecture or platform, (e.g., the Internet or a wide area network) or combinations thereof. Generally, network 104 provides an infrastructure to interconnect server 108, client devices 112, secondary platforms 120, and primary platforms 116.

Client device 112 can be a wearable device, smart glasses, smartphone, tablet, personal computer, smart home system, smart appliance, smart television, or the like, and is configured to transmit an electronic request to server 108. The electronic request including data relevant to electronic responses from one or more primary platforms 116 and/or secondary platforms 120. Client device 112 is further configured to receive parameters and ratings from server 108. Client device 112 may be further configured to transmit a response, such as a selection, and/or workflow interaction associated with a primary platform 116 or a secondary platform 120, to server 108.

Each primary platform 116 can be based on any present or future electronic media servers that publish content for client devices 112. The content provided by primary platform 116 can include primary content requested by client devices 112, while also including secondary content including parameters for secondary platform 120. Specific example types of primary content will be discussed in greater detail below.

Each secondary platform 120 can be based on any present or future electronic media servers that transmit parameters for a secondary service provider. Secondary platform 120 is configured to transmit parameters to server 108 via network 104. In some implementations, secondary platform 120 is further configured to receive ratings from server 108. Each secondary platform 120 may be further connected to an administrator terminal 124 for generating the secondary content. Administrator terminals 124 can be any type of human-machine interface for controlling secondary platforms 120. For example, administrator terminals 124 can include personal computers, smart phones, tablet computers, and any other device that can be used to output prompts, receive inputs, and generate secondary content in response to the inputs. Administrator terminal 124 may include an input device such as a traditional keyboard, and/or mouse to provide physical input, and an output device such as a display for outputting prompts. In general terms, administrator terminal 124 is controlled by personnel at a law firm to enter marketing materials, fee schedules, and other information about the services offered by the law firm.

In general, primary services include primary electronic workflows that invoke the provision of secondary services that include secondary electronic workflows, where the secondary workflows represent legal services that fulfill the provision of the primary electronic workflows.

To elaborate, primary platforms 116 can publish primary content pertaining to the provision of a primary service in the form of electronic workflows such as insurance brokerage, legal information, a directory of professionals, education information, school admissions counselling, job placement services, financial planning, real estate transactions, tax preparation and filing, marriage licensing, funeral services, or the like. The electronic workflow can comprise one or more steps implemented by primary platforms 116 to fulfill the primary service. Furthermore, primary platforms 116 can include “wrapper” workflows common to an e-commerce environment including a sales workflow or interactive sales function for a client device 112 representing a customer experience sales funnel, including experiences such as service searching, service browsing, acquiring user information, adding a service to shopping cart, checkout, and payment processing. As part of the sales workflow, primary platform 116 can embed parameters of secondary platform 120 so that a sales workflow for the secondary service is integrated with the primary service electronic workflows.

The secondary service may be a legal service, expressed in system 100 in the form of electronic workflows, that is required to fulfill the primary service or is otherwise related to the primary service, such as title searching, tax advice, preparation or review of marital agreements, estate planning, immigration services, criminal defense, employment contract review, or any other legal service associated with the fulfillment of the primary service electronic workflows. In a specific, non-limiting example, the primary service is a mortgage provided by a financial institution operating a primary platform 116, and the secondary service is an electronic workflow representing review and execution of a mortgage agreement corresponding to the mortgage.

Example areas of law provided by the secondary service can thus include employment law, family law, real estate, wills, but the areas of law are not particularly limited. Service types can thus include an employment contract, employment termination, workplace policies, child travel consent, cohabitation agreement, premarital/prenuptial agreement, separation agreement, uncontested divorce, buying a home, reviewing a purchase agreement from a builder, selling a home, power of attorney for personal care, power of attorney for property, wills, and the like.

Generally, the embedded content and sales funnel include, amongst other things, a quote for the secondary service as offered by one or more legal service providers operating a respective secondary platform 120. Accordingly, client device 112 can request both the primary and secondary services through primary platform 116.

Having described an overview of system 100, it is useful to comment on the hardware infrastructure of server 108.

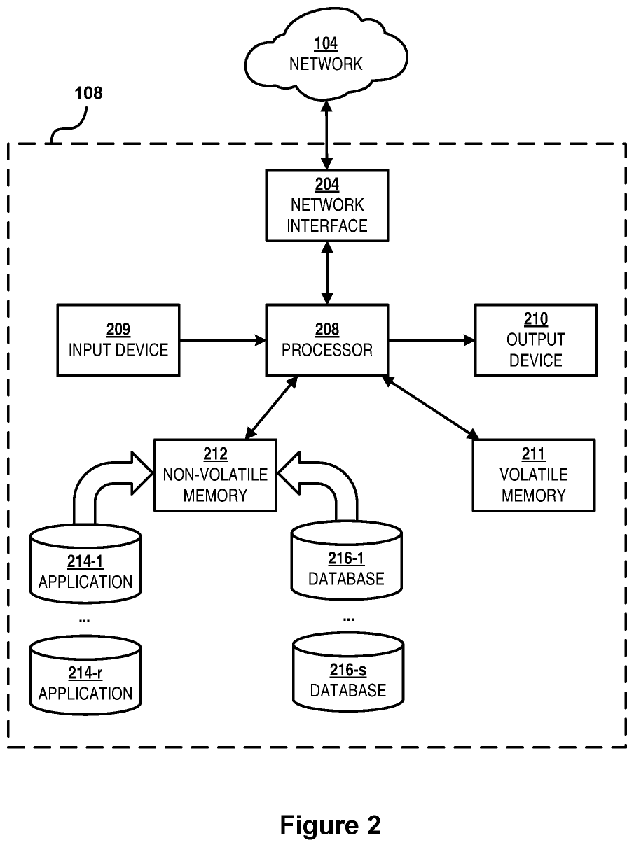

FIG. 2 is a schematic diagram showing a non-limiting example of internal components of server 108.

To communicate with primary platform 116, secondary platform 120, and client device 112, server 108 includes a network interface 204.

Processor 208 may be implemented as a plurality of processors or one or more multi-core processors. The processor 208 may be configured to execute different programming instructions responsive to an input received at an input device 209 and to control an output device 210. Input device 209 can be a traditional keyboard and/or mouse to provide physical input. Likewise output device 210 can be a display. In variants, additional and/or other input devices 209 or output devices 210 are contemplated or may be omitted altogether as the context requires. (For example, network interface 204 can also be used to connect another client device on network 104 that has an input (e.g., keyboard, mouse) and output device (e.g., monitor) to provide remote administrative control over server 108.)

To fulfill its programming functions, the processor 208 is configured to communicate with one or more memory units including volatile memory 211 and non-volatile memory 212. Non-volatile memory 212 can be based on any persistent memory technology, such as an Erasable Electronic Programmable Read Only Memory (“EEPROM”), flash memory, solid-state hard disk (SSD), other type of hard-disk, or combinations thereof. Non-volatile memory 212 may also be described as a non-transitory computer readable media. Also, more than one type of non-volatile memory may be provided. Volatile memory 211 is based on any random-access memory (RAM) technology. For example, volatile memory 211 can be based on Double Data Rate (DDR) Synchronous Dynamic Random-Access Memory (SDRAM). Other types of volatile memory are contemplated.

Programming instructions in the form of applications 214 are typically maintained, persistently, in non-volatile memory 212 and used by the processor 208 which reads from and writes to volatile memory 211 during the execution of applications 214. One or more tables or databases 216 are maintained in non-volatile memory 212 for use by applications 214.

The infrastructure of server 108, or a variant thereon, can be used to implement any of the computing nodes in system 100, including primary platforms 116 and secondary platforms 120. Furthermore, it is to be understood that server 108, primary platform 116, and secondary platform 120 may be implemented as virtual machines and/or with mirror images.

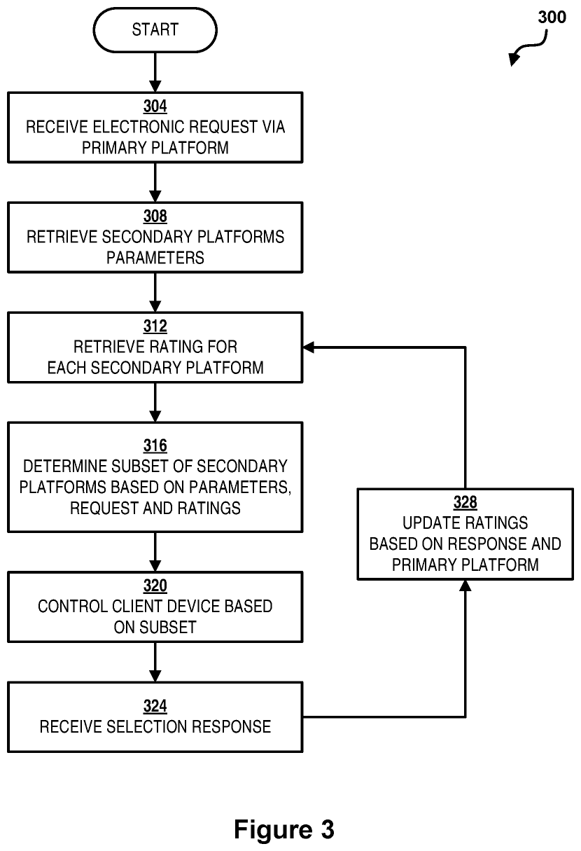

Referring now to FIG. 3, a method for integrating primary and secondary platforms in accordance with another embodiment of the disclosure is represented as a flowchart and indicated generally at 300. Persons skilled in the art may choose to implement method 300 on system 100 or variants thereon, or with certain blocks omitted, performed in parallel or in a different order than shown. Method 300 can thus also be varied.

Block 304 comprises receiving an electronic request representing a request for a primary service. In system 100, block 308 is performed by server 108 which receives the electronic request from client device 112 via primary platform 116. The electronic request at least comprises primary request parameters but may further infer secondary request parameters. In general terms, the electronic request thus identifies the primary service but may further include data pertaining to the client and the primary service. Due to overlap between the nature of the primary and second services, it may only be necessary for the electronic request to include primary request parameters, however in some examples, the electronic request further includes secondary request parameters.

As noted above, primary services can include primary electronic workflows that invoke the provision of secondary services that include secondary electronic workflows, where the secondary workflows represent legal services that fulfill the provision of the primary electronic workflows.

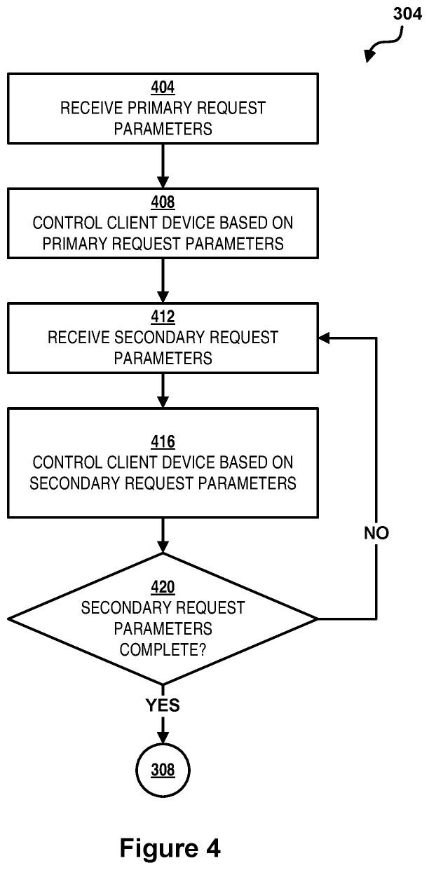

An exemplary performance of block 304 is shown in greater detail at FIG. 4.

At block 404, server 108 receives the primary request parameters from client device 112 for the desired primary platform 116. Non-limiting examples of the primary request parameters include identification and/or authentication elements such as client name, client contact information, client payment details, a photo of the client, a government-issued identity card for the client, client biographical details. The primary request parameters can also include a primary service type, and details specific to the nature of the primary service. Other primary service parameters can intersect with the secondary service, such as a legal jurisdiction, a preferred legal fee budget, a preferred deadline.

At block 408, server 108 controls client device 112 via primary platform 116 to output prompts implementing interactive workflows based on primary request parameters. The prompt may request the secondary request parameters. Non-limiting examples of secondary request parameters can include for example, field of law, service type, legal jurisdiction, preferred legal fee budget, preferred deadline, preferred geographic location of the law firm, preferred spoken language, preferred years of experience, preferred rating, and details specific to the nature of the secondary service.

Server 108 may control client device 112 to output a prompt according to the primary service request. In one example, the primary request parameters indicate that the primary service is a funeral service, and the prompt requests a selection of the area of law as either estates law or real estate law.

As a more detailed example, where the primary service type from block 404 involves negotiating a mortgage via a workflow offered by a financial institution operating a primary platform 116, then the details of the primary service can include a legal address of the property, a copy of the agreement of purchase and sale for the property, the amount of the purchase price and the amount of the mortgage. Such a primary service thus infers the need to interact with a secondary service, specifically preparation and execution of a mortgage agreement in the form of a set of mortgage agreement workflows available from a real estate lawyer offering legal services via a respective secondary platform 120 operated by the real estate lawyer.

At block 412, server 108 receives the secondary request parameter from client device 112 via primary platform 116. The secondary request parameter may be stored in non-volatile memory 212 at server 108.

At block 416, server 108 controls client device 112 to output additional prompts based on the secondary request parameters received at block 412. In a non-limiting example, server 108 receives a secondary request parameter comprising the area of law at block 412 and controls client device 112 at block 416 to output a prompt requesting the service type. In a particular non-limiting, server 108 receives secondary request parameters indicating that the area of law is real-estate law and controls client device 112 to display a prompt requesting a selection of mortgage agreement preparation and execution.

At block 420, server 108 determines whether the secondary request parameters are complete. If the secondary request parameters are complete, the method 300 proceeds to block 308. If the secondary request parameters are not complete, the method 300 returns to block 412 with server 108 receiving the secondary request parameter and then controlling client device 112 again at block 416. Generally speaking, the process of acquiring secondary request parameters can be an iterative workflow, wherein each secondary request parameter received at server 108 can elicit a subsequent prompt for another secondary request parameter. In this way, prompts output at client device 112 are curated so as not to waste computing resources.

In some examples, server 108 infers the secondary request parameters from the primary request parameters and therefore blocks 412, 416, and 420 are omitted in these examples.

The prompts output at client device 112 as part of block 304 may comprise a graphical user interface (GUI) displayed at a user interface. The GUI may display the prompts and receiving inputs comprising the secondary request parameters. The graphical interface may receive inputs through radio buttons, text fields, switches, checkboxes, drop down menus, date pickers, time pickers, file attachments, sliders, and the like. In general terms, the GUI is embedded into the content of primary platform 116 such that the GUI has the same look and feel as primary platform 116.

Returning now to FIG. 3, block 308 comprises retrieving secondary platform parameters. In system 100, block 308 is performed by server 108 which retrieves the secondary platform parameters from non-volatile memory 212. In general terms, block 308 comprises determining which secondary platforms 120 provide workflows representing legal services that complement the workflows representing the primary service of the platform 116 which received the initial request at block 304. According to our specific example, where the primary service is a fulfillment of a mortgage, then block 308 comprises determining which secondary platforms 120 include legal services that represent the preparation of a mortgage agreement between a borrower (i.e., the individual operating the requesting client device 112) and the lender (i.e. the financial institution operating primary platform 116).

Server 108 typically only retrieves a subset of the secondary platform parameters, in other words, the portion of those parameters that are sufficient to allow the selection of a secondary platform 120 that has an appropriate association between client device 112 that made the request at block 304 and the respective primary platform 116. The retrieved subset of secondary platform platforms may be selected based on a comparison between the electronic request and the secondary platform parameters, which can be stored in non-volatile memory 212 at server 108. The comparison may be based on one or more aspects of the electronic request and one or more aspects of the secondary platform parameters. Generally, some of the secondary platforms 120 will correspond to legal service providers who do not offer the requested legal service in the relevant jurisdiction. (As per our specific example of a mortgage agreement, if the mortgage is issued under the laws of New York, then a secondary platform 120 of a legal services provider that provides mortgage agreements but only in the State of Nevada will be omitted from the retrieved subset). Server 108 may further exclude some secondary platforms 120 from retrieval at block 308 according to the electronic request. For example, the electronic request may indicate the existence of a legal or business conflict rendering one of more secondary platforms 120 unsuitable for the electronic request. By retrieving only a portion of the secondary platform parameters, computing resources can be conserved at server 108, as compared to certain prior art searches that cannot filter well for legal conflicts and/or authorization to practice in a given legal jurisdiction.

The secondary platform parameters are then stored in non-volatile memory 212 at server 108 in response from receiving the secondary platform parameters from secondary platform 120. The secondary platform parameters may be stored in association with a platform identifier that uniquely identifies secondary platform 120 from which the parameter was received. Periodically, the secondary platform parameters may be updated by receiving updated secondary platform parameters from secondary platform 120.

Secondary platforms 120 may receive the secondary platform parameters as inputs received at administrator terminals 124. In some examples, server 108 controls administrator terminal 124-1 to output a prompt requesting a secondary platform parameter. In response to receiving an input, administrator terminal 124-1 generates a secondary platform parameter and transmits the secondary platform parameter to server 108. The prompts output at administrator terminal 124 may comprise a GUI output at a display. Server 108 may control the GUI to display prompts and receive inputs comprising the secondary platform parameters. The GUI may receive inputs through radio buttons, text fields, switches, checkboxes, drop down menus, date pickers, time pickers, file attachments, sliders, and the like.

The process of acquiring secondary platform parameters may be iterative. Server 108 can query administrator terminals 124 to obtain, for example, a list of legal fields of specialization and then iterate to fields of sub-specialization. The parameters from secondary platform 120 may be displayed at client device 112 as part of block 304. In one example, both the prompt displayed at client device 112 and the prompt displayed at administrator terminal 124 include a list of the same fields of specialization (and/or sub-specializations) of law and client device 112 can receive a selection based on that list. This curation as described, provides efficiencies in utilization of computing and networking resources that would otherwise be wasted on processing and transmitting irrelevant data in the form of over-broad search results.

Non-limiting examples of secondary platform parameters that characterize the services offered via given secondary platform 120 will be described in greater detail below.

For example, secondary platform parameters may include identifying business information pertaining to a law firm. Such business information may include the business name, tax information, license number, title, location information, street address, a biography of the law firm and its professionals, a website hyperlink, and the like.

Secondary platform parameters may include personal information pertaining to a legal professional associated with a particular specialization or sub-specialization. The personal information may include first and last name, a profile picture, contact information (such as an email address and phone number), and the like.

Secondary platform parameters may include the legal professional's qualifications. Such information may include the year of call, jurisdiction(s) where the legal professional is licensed to practice law, years of experience, professional awards, certificates, areas of expertise, biographical data, resume or curriculum vitae, personal references, professional references, languages spoken, and the like.

Secondary platform parameters may include the secondary service provider's availability. Such information may include hours of availability and current workload.

Secondary platform parameters may include rate data. The rate data is not particularly limited and can include any information relevant to fee calculations for services provided by the secondary service provider. In some examples, the rate data include a selected service and a base fee representing the secondary service provider's fee for the secondary service. In other examples, the rate data further comprise one or more rate modifiers which increase or decrease the base fee for the selected service according to a variable. In some embodiments, rate modifiers add or subtract an absolute value from the base rate. In other embodiments, rate modifiers add or subtract a percentage of the base rate. Each service type may correspond to a unique set of rate modifiers. In a non-limiting example, the cost of a title search only applies to certain real estate transactions and is not relevant to reviewing an employment contract. The rate data may further comprise a currency. The rates may be expressed as hourly or flat rate.

In some examples, a portion of the secondary platform parameters are generated at server 108. The secondary platform parameters can be generated at server 108 if a parameter is not received from secondary platform 120. In general terms, a secondary platform parameter generated at server 108 may be called a default parameter. When acquiring secondary platform parameters from secondary platforms 120, server 108 may further control the relevant secondary platform to display the default parameter. If no input is received to replace the default parameter, the default parameter is stored in non-volatile memory 212 in association with the respective platform identifier.

Secondary platform parameters stored in non-volatile memory 212 at server 108 may be updated periodically by secondary platform 120 sending a signal to server 108, the signal comprising updated secondary platform parameters.

Block 312 comprises retrieving a rating for each secondary platform parameter retrieved at block 308. In system 100, block 312 is performed by server 108 which retrieves a rating stored in non-volatile memory 212 in association with one of the secondary platform parameters. Ratings will be described in greater detail with respect to block 324. Generally, the rating represents a quality of a match between a primary workflow respective to primary platform 116-1 and a secondary workflow that complements the primary workflow and which is hosted by each of secondary platforms 120.

Block 316 comprises determining a subset of secondary platforms based on the parameters, the electronic request, and the ratings. In system 100, block 316 is performed by server 108 which selects the subset from the secondary platform parameters retrieved at block 308. In general terms, the subset of secondary platforms 120 represents a potential list of platforms for which client device 112 may access for a secondary service of workflows that are provided in association with a primary service of workflows that are provided by primary platform 116 from block 304.

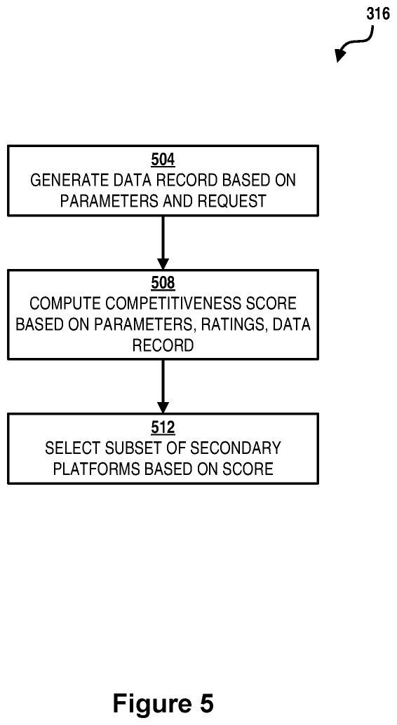

Exemplary performance of one way to implement block 316 on system 100 is shown in FIG. 5.

At block 504, server 108 generates a data record for each secondary platform 120 corresponding to the secondary platform parameters that were retrieved at block 308. Server 108 generates the data records according to the electronic request as well as the rate data included in the secondary platform parameters. Each data record comprises a numerical value representing a quoted fee for the provision of the secondary service. The data record may further include a currency.

In a particular example, server 108 generates the data record based on the base rate indicated in the rate data. Server 108 may further calculate the quote based on the secondary request parameters and the rate modifiers. In a non-limiting example of a mortgage agreement, the electronic request includes a secondary request parameter indicating that registration of the mortgage is required, and the rate data includes a rate modifier of $50 for registering a deed. Server 108 thus adds $50 to the base rate of secondary platform 120. In another non-limiting example, the electronic request includes a secondary request parameter indicating that a title search is not required by the financial institution operating primary platform 116, and the rate data includes a rate modifier of $75 for conducting a title search, then the $75 fee would be omitted from the base rate. Other examples of inclusion or exclusion of rate modifiers will now occur to those skilled in the art.

As part of block 504, server 108 can also generate the data record to include a disbursement. Server 108 may identify the disbursement based on the electronic request. The disbursement may be retrieved from a tertiary platform (not shown, but according to our example, could include a government website listing various transactions involving mortgage registry) in response to receiving the electronic request. In some examples, the disbursement is retrieved from non-volatile memory 212 and updated periodically by retrieving the disbursement from the tertiary platform. In general terms, the disbursement represents a fee paid to a third party and may include government fees, court fees, process server fees, travel costs, photocopying charges, expert witness fees, and the like.

At block 508, server 108 computes a competitiveness score for each of the secondary platform parameters retrieved at block 308, the competitiveness score based on the secondary platform parameters, the ratings, and the data record generated at block 504. In general terms, the competitiveness score represents the likelihood that client device 112 will select the respective secondary platform 120. In some examples, applications 214 may include machine learning and/or deep-learning based algorithms and/or neural networks, and the like, which are trained to improve the competitiveness score. Furthermore, in these examples, applications 214 may be operated by server 108 in a training mode to train the machine learning and/or deep-learning based algorithms and/or neural networks of applications 214 in accordance with the teachings herein.

The one or more machine-learning algorithms and/or deep learning algorithms and/or neural networks of applications 214 may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms; reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like. To be clear, any suitable machine-learning algorithm and/or deep learning algorithm and/or neural network is within the scope of present examples.

Such machine learning and/or deep-learning based algorithms can, for example, track demographic information associated with the users of each client device 112, the nature of the requests from block 304, and the parameters associated with each primary platform 116 and each secondary platform 120. With sufficient training, the algorithm can begin to determine patterns of which secondary platforms 120 tend to be selected for a new request between a client device 112 having a user of a certain demographic, and then rank secondary platforms 120 accordingly.

In another example, which can stand on its own or be combined with other examples, the competitiveness score is calculated by ranking the data records from high to low according to their respective numerical values. The lowest numerical value is assigned the highest competitiveness score and the highest quote is assigned the lowest competitiveness score. This example is thus purely based on which secondary platform 120 has the lowest rates. In another example, which can stand on its own or be combined with other examples, the competitiveness score is calculated by ranking the data records from high to low according to the subjective ratings by a given client device 112 and/or primary platform 116 of the respective secondary platform 120. The lowest rated secondary platform parameter is assigned the lowest competitiveness score and the highest rated secondary platform parameter is assigned the highest competitiveness score. It should be recognized that the lowest quote is not necessarily the best option as it may reflect a low quality of service. Nor does the highest quote indicate the highest quality of service. Similarly, the highest rated quote may not provide a competitive price for the services. Furthermore, competitive pricing may depend on the location of the legal practitioner; a price that is competitive in Toronto may not be considered competitive in Cornwall. Therefore, in further examples, server 108 calculates the competitiveness score based on the quote and at least one other characteristic of the secondary platform parameters such as the rating, years of experience, location, the like, or a combination thereof.

To improve the reliability of the competitiveness score, server 108 may compute the competitiveness score based on further calculations. In one example, server 108 calculates a standard deviation for the data record relative to all of the data records calculated at block 504 and then computes the competitiveness score based on the numerical value of the data record and the calculated standard deviation. In this way, server 108 may identify data records that are outliers.

At block 512, server 108 selects a subset of secondary platforms 120 based on the competitiveness score calculated at block 508. In some examples, server 108 selects a pre-determined number of secondary platforms 120 having the highest ranking. In certain examples, the subset includes only the secondary platforms 120 associated with a competitiveness score that meets or exceeds a pre-determined threshold. The pre-determined threshold may be selected to exclude secondary platforms 120 that are unlikely to be chosen by client device 112. The subset may comprise any suitable number of secondary platforms 120. In some examples, the subset comprises one secondary platform 120.

Returning now to FIG. 3, block 320 comprises controlling client device 112 to generate the subset of secondary platforms determined at block 316. As part of block 320, server 108 transmits the subset of secondary platforms to client device 112 via primary platform 116 and requests a selection at client device 112 from the subset. In addition to the subset of secondary platforms, server 108 may transmit secondary platform parameters corresponding to the secondary platforms 120 in the subset of secondary platforms 120 to assist in the selection at client device 112. (Alternatively, the selection may be automatic, such as the highest competitiveness score, based on a pre-established criterion.)

Server 108 may control client device 112 to display the subset of secondary platforms at a user interface on the display of client device 112. Server 108 may control client device 112 to display the subset of secondary platforms 120 in an order according to the respective rankings determined at block 508. In one example, client device 112 displays the subset of secondary platforms beginning with secondary platform 120-1 corresponding to the highest ranking, followed by secondary platform 120-2 corresponding to second highest ranking, and so on. In another example, client device 112 groups the secondary platforms according to the respective rankings. The groupings may be designated by color, number, words, or the like. In an example where groupings are designated by text, secondary platforms 120 that are assigned a competitiveness score above a first threshold may be categorized as “excellent”, quotes that are assigned a competitiveness score below the first threshold but above a second threshold lower than the first threshold may be categorized as “good”, and quotes that are assigned a competitiveness score below the second threshold may be categorized as “fair”. In general terms, server 108 can be configured so that client device 112 only displays the quotes that are most likely to be chosen by the user. As compared to certain prior art Internet searches, computing resources are not wasted by displaying results that are unsuitable for the request at block 304.

Displaying the subset of secondary platforms 120 may include displaying secondary platforms parameters associated with the subset of secondary platforms 120, but typically only a portion of secondary platform parameters are transmitted and displayed at client device 112. In one example, client device 112 displays only the business name and quote for the service providers.

Returning now to FIG. 3, block 324 comprises receiving a selection response. Block 324 is performed by server 108 which receives a selection response from client device 112. According to an illustrative example, which will be discussed further below, the selection response indicated a selected one of the subset of secondary platforms 120-1. Furthermore, it will be assumed that the request from block 304 was made by client device 112-1 at primary platform 116-1.

In some examples, server 108 does not receive a selection response from client device 112 at block 324 and method 300 terminates. As part of block 324, server 108 may update a conversion rate stored in non-volatile memory 212, the conversion rate representing the frequency at which server 108 receives or fails to receive a selection response at block 324. The conversion rate may be used by server 108 to compute the competitiveness score for the subset of secondary platforms 120 upon subsequent performance of block 508.

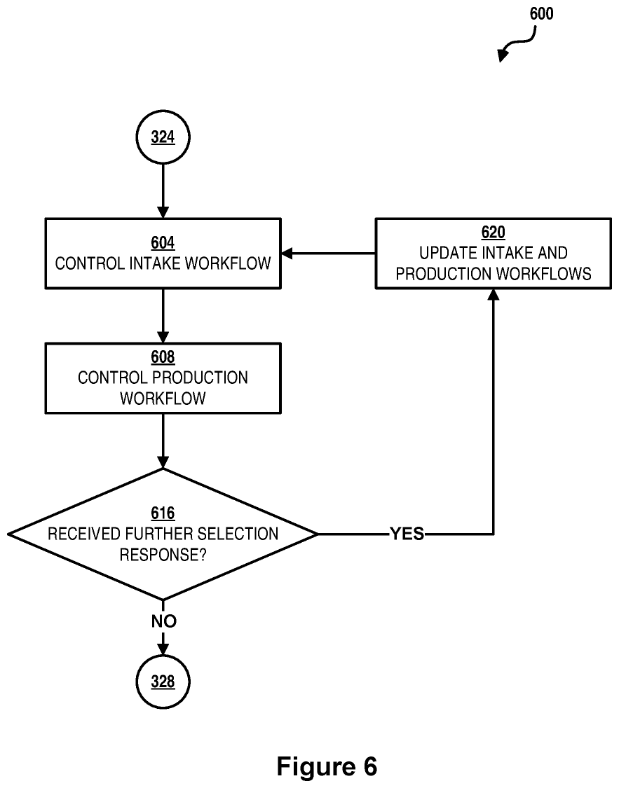

In response to receiving the selection response, server 108 can further manage a workflow, as shown generally at 600 in FIG. 6. In the example shown, method 600 is performed between blocks 324 and 328.

Block 604 comprises controlling client device 112-1, primary platform 116-1, and the selected secondary platform 120-1 to generate an intake workflow. In system 100, block 604 is performed by server 108 in response to receiving a selection response. In one embodiment, the intake workflow comprises a plurality of instructions stored in non-volatile memory 212 at server 108 in association with an identifier indicating whether the respective step in the workflow is to be performed by server 108, client device 112-1, primary platform 116-1, secondary platform 120-1, or a combination thereof. According to the identifier, the instruction may be transmitted to client device 112-1, primary platform 116-1, or secondary platform 120-1. Some instructions can be performed in series, while other instructions are performed in parallel. Each instruction can include a start date and a deadline. The intake workflow may include steps to verify the identity of the user of client device 112-1, such as transmitting a copy of the client's photo identification from client device 112-1 to primary platform 116-1 and/or secondary platform 120-1. According to legal services regulations, the identification can include performing a conflict check at secondary platform 120-1 and transmitting payment information from client device 112 to secondary platform 120-1. Other intake workflow steps will now occur to those skilled in the art. Note another resource processing efficiency of system 100 at this point, in that a single intake can be effected for both primary platform 116-1 and secondary platform 120-1 thereby reducing duplication of computing resources to effect separate intakes at primary platform 116-1 and secondary platform 120-1.

Block 608 comprises controlling client device 112-1, primary platform 116-1, and secondary platform 120-1 to generate one or more production workflows that represent the primary service workflows of primary platform 116-1 and the second service workflows of secondary platform 120-1. In a present embodiment, block 608 can performed centrally by server 108. (In other embodiments, the workflow performance can be centrally administered by server 108 handing off respective performance of primary service workflows to primary platform 116-1 and secondary service workflows to secondary platform 120-1). In the present embodiment, the production workflow combines both primary service workflow and secondary service workflows and is centrally administered by server 108. The primary service workflow and secondary service workflow comprise a plurality of instructions or workflow steps stored in non-volatile memory 212 at server 108 in association with an identifier indicating whether the respective instruction is to be performed by server 108, client device 112-1, primary platform 116-1, secondary platform 120-1, or a combination thereof. According to the identifier, the instruction may be transmitted to client device 112-1, primary platform 116-1, or secondary platform 120-1. The instructions can be determined according to default workflows, respective to the type of legal service, applicable to all primary platforms 116 and/or all secondary platforms 120 that relate to that legal service, as stored in non-volatile memory 212. Such workflows can thus be based on the nature of the electronic request from block 304, secondary platform parameters, or a combination thereof and/or other factors. Some workflow instructions can be performed in series, while other instructions can be performed in parallel depending on whether the performance of the workflow step is required at client device 112-1, primary platform 116-1 and/or secondary platform 120-1. Each instruction or workflow step can include a start date and a deadline. The instructions may vary depending on service type and can include generating a scope of engagement for the secondary platform 116-1, receiving approval from client device 112-1 for the scope of engagement, transmitting a reminder signal to primary platform 116-1 or secondary platform 120-1, transmitting work product to client device 112, and receiving approval of the work product from client device 112.

In plain terms, server 108 establishes and monitors the workflow of legal services between the user operating client device 112-1 and the legal service professional operating secondary platform 120-1 and the representative of primary platform 116-1. Since the production workflow is managed centrally by server 108, it may not be necessary to duplicate any instruction that is required by both primary platform 116 and secondary platform 120-1.

As part of blocks 604 and 608, server 108 may receive feedback data from one or more of client device 112, secondary platform 120-1, and primary platform 116. The feedback data may include the time taken to complete the secondary service, whether or not deadlines were met, client satisfaction with the selected secondary platform 120-1, satisfaction of the primary service provider with the selected secondary platform 120-1, client satisfaction with the data record, a quote received by client device 112 from a source other than server 108, a quote received by primary platform 116 from a source other than server 108, quality of the secondary service, responsiveness of selected secondary platform 120-1, responsiveness of client device 112, whether or not the client would hire selected secondary platform 120-1 again, and the like, all of which can form part of future competitiveness scores from block 508.

In some examples, method 600 comprises receiving a further selection response from client device 112, as indicated at block 616. In system 100, block 616 is performed by server 108 which determines whether a further selection response has been received at server 108, the further selection response indicating a different secondary platform 120-2. Block 616 thus represents the performance of additional steps in the workflows.

If a further selection response is received, server 108 proceeds to block 620 and updates the intake and production workflows stored in non-volatile memory 212 based on the further selection response. Updating the intake and production workflows may comprise updating the identifiers that indicate secondary platform 120-1 to instead indicate secondary platform 120-2. Updating the intake and production workflows may further comprise duplicating an instruction that has already been performed. Examples of instructions that may need to be duplicated include transmitting a copy of the client's photo identification, performing a conflict check, and transmitting payment information, or fulfillment of an authorization to transfer funds from trust. Once the workflows have been updated, method 600 returns to blocks 604 and 608, implementing the updated intake and production workflows.

In general terms, a client operating device 112-1 may wish to switch to a different law firm operating a different secondary platform 120-2 before the production workflow is complete. Since the client data and workflows are managed centrally by server 108, no databases need to be transferred to effect the transition, minimal processing power is expended at secondary platform 120-1 and secondary platform 120-2, there is little impact on the load of network 104, and the transition workflows on client device 112-1 are minimized provided a simplified user-experience.

If server 108 determines that no further selection response is received at block 616, server 108 proceeds to block 328.

Returning now to FIG. 3, block 328 comprises updating the ratings based on the selection response. In system 100, block 328 is performed by server 108 which updates the ratings stored in non-volatile memory 212. On subsequent performance of method 300, the updated rating influences which secondary platforms 120 are included in the subset determined at block 316. The updated ratings may likewise also influence the competitiveness scores of block 508.

In one example, server 108 updates each rating to include the frequency at which the respective secondary platform 120 is selected by client devices 112. At block 316, (and/or block 508) server 108 computes the competitiveness score based on historical popularity of the secondary platform parameters. If the respective secondary platform parameter has never or rarely been chosen, the competitiveness score will be lower than if secondary platform 120 has frequently been chosen by other client devices 112.

As part of block 328, server 108 may further receive feedback data from client device 112, primary platform 116, and secondary platform 120 which is stored in memory at server 108. Server 108 may further update the ratings based on the feedback data. Feedback data may include the number of communications transmitted between secondary platform 120 and client device 112, actual time taken by secondary platform 120 to complete the service, and the like.

Server 108 may further update the ratings according to the electronic request and the secondary service parameters. In particular, server 108 may update the ratings to include client information of the user of a respective client device 112, personal information pertaining to the secondary service provider, or business information pertaining to the secondary service provider, or combinations thereof. In more general terms, server 108 personalizes the rating according to attributes of the client and the service provider. As more feedback is accumulated, the ratings may reflect which clients are more likely more likely to choose which quotes or which clients are more likely to be satisfied by the service provider. In a non-limiting example, clients may be more likely to select lawyers with similar demographic data or similar risk tolerances. Certain clients may value timeliness while other clients value communication while others may value rates.

After updating the ratings, server 108 can transmit each rating to the respective secondary platform 120 to provide performance feedback to the legal service provider operating secondary platform 120 and to permit adjustments to help the legal service provider improve its future ratings and likelihood of selection. Likewise, server 108 can control secondary platforms 120 to generate updated secondary platform parameters. In a non-limiting example, assume secondary platform 120-2 was not selected at block 324, so at block 328, server 108 decreases the rating for the secondary platform parameters that were determined at block 316 and associated with secondary platform 120-2. In response to receiving the updated rating, secondary platform 120-2 generates updated platform parameters which are received at server 108. Server 108 updates the secondary platform parameters stored in non-volatile memory 212. As an example of offering performance improvement, secondary platform 120-2 that was not selected at block 304 can lower their quotes in order to improve their competitiveness score.

Thus, in examples where server 108 relies on updated ratings to determine the selection at block 316, the algorithm is iterative. The relevance of the secondary platforms delivered to client device 112 may improve over time as server 108 collects more feedback data about client preferences.

The feedback data received at block 328 may also be used to control production workflows on subsequent performance of block 608. Instead of implementing a production workflow received from secondary platform 120, server 108 may generate a production workflow based on feedback data stored in non-volatile memory 212. The production workflow generated at server 108 may include suggested timeframes for completing tasks and templates for completing work products.

As will now be apparent to those skilled in the art, the method 300 may be performed without primary platform 116. In these examples, client device 112 and secondary platform 120 communicate directly with server 108, thereby permitting a client device 112 to select a legal service provider directly, in more computationally efficient fashion than prior art search.

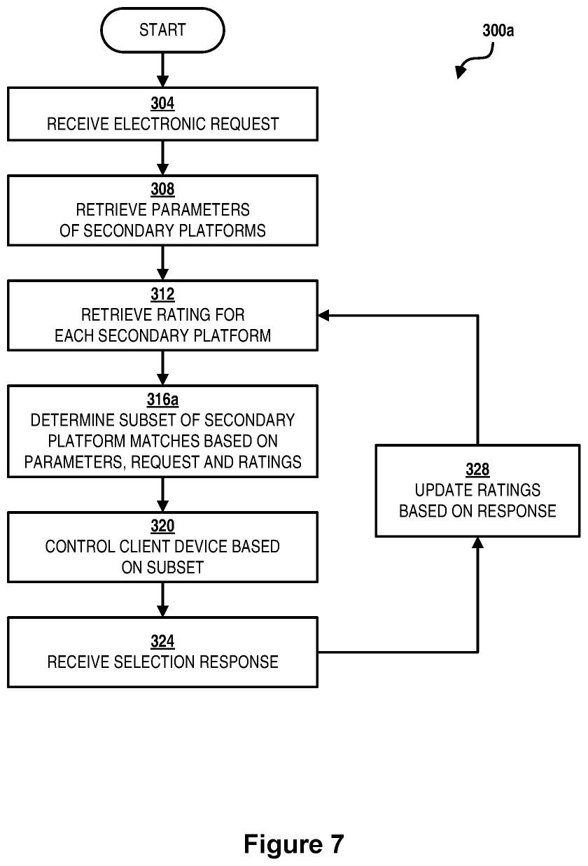

FIG. 7 shows method 300a. Method 300a is a variant on method 300, and like blocks bear like references, except followed by the suffix “a”. Notably, however, method 300a includes block 316a which is not present in method 300. While the remainder of blocks in method 300a function substantially the same as their counterparts in method 300, block 316a modifies the original performance of method 300 as will be explained further below. Block 316a generally comprises determining a subset of secondary platform matches. The matches can be based on secondary platform parameters, the nature of the request from block 304, and/or ratings.

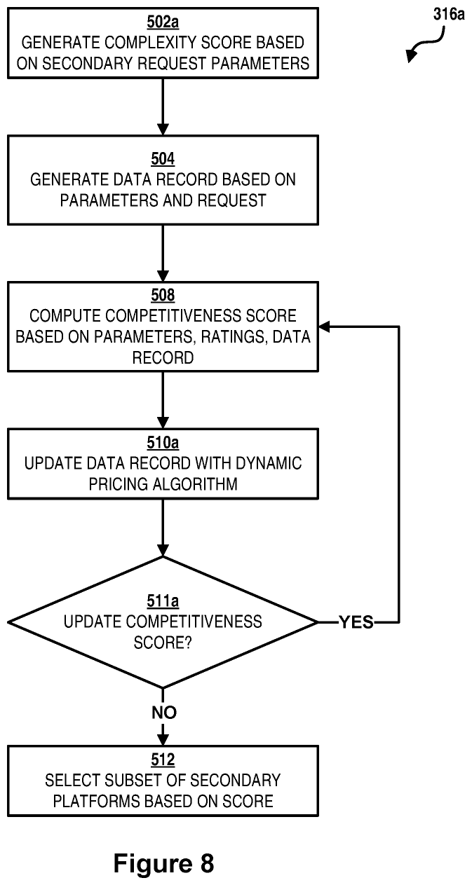

Exemplary performance of block 316a is shown in FIG. 8. Notably, block 316a includes block 510a and block 511a, which are not present in block 316. Again, block 316a performs substantially the same way as block 316, except that block 510a comprises updating a data record with a dynamic pricing algorithm, where that pricing is relevant to the competitiveness score at block 508.

Server 108 may apply the dynamic pricing algorithm only to a portion of secondary platforms 120. In one example, server 108 applies the dynamic pricing algorithm of block 316a only to secondary platforms 120 identified in secondary platform parameters that include a selection to participate in dynamic pricing. If the respective secondary platform parameters include a selection to opt out of dynamic pricing, server 108 instead applies block 316 to generate a data record for the respective secondary platform 120. In examples where platform parameters include a selection for dynamic pricing, the platform parameters may further include a minimum value for the data record. A platform 120-1 can associate the selection for dynamic pricing with all or a portion of the respective secondary platform parameters. For example, the selection for dynamic pricing may be associated with selected service types or areas of law. Generally, a service provider may choose to apply dynamic pricing to the quotes generated at server 108 or choose to maintain more direct control over their quotes.

Block 502a comprises generating a complexity score for the electronic request based on the secondary request parameters. In a non-limiting example of preparing a will, the complexity score will be higher if the secondary request parameters indicate that the client is married, divorced, has children, owns multiple home, owns pets, owns a business, or has a pension plan; the complexity score will be lower if the secondary request parameters indicate that the client is unmarried, is childless, does not own a home, does not own a pet, does not a business, or does not have a pension plan. In general terms, the complexity score predicts the time and effort required by the platform 120 to provide the secondary service.

The complexity score may be further generated based on the feedback data received by server 108 at block 328. Feedback data can include the actual time taken by platforms 120 to perform the secondary service, the number of communications transmitted between client device 112 and platform 120, whether the platform 120 updated the data record, the service provider's year of call, the geographical distance between client device 112 and platform 120, the identity of the client, and the like. Thus, feedback data can be used to refine the complexity score and consequently the quote.

The complexity generated at block 502a be further applied by server 108 on subsequent performance of block 608 to generate the production workflow. In some examples, server 108 may suggest timelines for completing tasks in the production workflow according to the complexity score.

Block 510a comprises updating the data records generated at block 504 using a dynamic pricing algorithm. In system 100, block 510a is performed by server 108 in response to generating data records at block 504. The dynamic pricing algorithm may comprise machine learning and/or deep-learning based algorithms and/or neural networks, and the like, which are trained to improve the data records. Furthermore, in these examples, server 108 may operate in a training mode to train the machine learning and/or deep-learning based algorithms and/or neural networks in accordance with the teachings herein.

The one or more machine-learning algorithms and/or deep learning algorithms and/or neural networks of the dynamic algorithm may include, but are not limited to: a generalized linear regression algorithm; a random forest algorithm; a support vector machine algorithm; a gradient boosting regression algorithm; a decision tree algorithm; a generalized additive model; neural network algorithms; deep learning algorithms; evolutionary programming algorithms; Bayesian inference algorithms; reinforcement learning algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like. However, generalized linear regression algorithms, random forest algorithms, support vector machine algorithms, gradient boosting regression algorithms, decision tree algorithms, generalized additive models, and the like may be preferred over neural network algorithms, deep learning algorithms, evolutionary programming algorithms, and the like. To be clear, any suitable machine-learning algorithm

The dynamic pricing algorithm adjusts the data record based on one or more variables. The variables may be retrieved from non-volatile memory 212, platforms 120, client device 112, tertiary platforms, or a combination thereof. The data records may be updated based on secondary platform parameters, ratings, competitiveness scores, market demand for platforms 120, availability of platforms 120, competitor pricing, deadlines specified in the electronic request, the complexity score generated at block 502a, the predicted time required to perform the selected service, historical feedback data representing the actual time taken by platform 120 to perform the selected service, historical feedback data representing the actual time take by platform 120 to perform a similar service, client demographics, years of experience of the service provider, or a combination thereof. For example, if the requested legal service needs to be performed the next day, server 108 may increase the quote represented by the data record. In another example, if the value of the data record for platform 120-1 is above or below the mean for all platforms 120, server 108 may adjust the data record to be closer or equal to the mean. In a further example, if the legal service is requested when platforms 120 in a geographical region or area of law have already recently received a high number of electronic requests, server 108 may increase the value of the data record. In a further example, if client device 112 is a regular user of server 108 or platform 120, server 108 may decrease the value of the data record. In a further example, if the deadline specified in the electronic request is on a weekend or holiday, server 108 may increase the value of the data record. In a further example, server 108 may increase the value of the data record for platforms 120 associated with certain geographical areas. In yet a further example, server 108 may increase the value of the data record if the preferred deadline is close to the current date and lower the value of the data record if the preferred deadline is far from the current date.

Thus, in examples where the dynamic pricing algorithm relies on historical feedback data stored at server 108, the dynamic pricing algorithm is iterative. The dynamic pricing algorithm may improve over time as server 108 collects more feedback data from platforms 120 and client devices 112. For example, server 108 can improve the dynamic pricing algorithm based on the rate at which client devices 112 select data records generated using the dynamic pricing algorithm, the rate at which platforms 120 select dynamic pricing, client drop-off rates, client satisfaction with quotes, and the like.

After updating the data records, server 108 determines at block 511a whether or not to update the competitiveness score based on the updated data record. If server 108 decides to update the competitiveness score, method 600 returns to block 508 and server 108 update the competitiveness score based on the updated data records. If server 108 decides not to update the competitiveness score, method 300a advances to block 512, previously described with respect to method 300. Blocks 508, 510a and 511a may be repeated any suitable number of times. When the iterations complete, then block 511a can advance to block 512.

In view of the above, it will now be apparent that variants, combinations, and subsets of the foregoing embodiments are contemplated. For example, while method 300 was discussed above in relation to securing a mortgage and closing a real estate transaction, other types of legal services are contemplated. For example, the primary service is purchasing a home from a builder or through an agent, and the secondary service is the legal service required to close the purchase or sale transaction. In another example, the primary service is providing life insurance by an insurer or insurance broker, and the secondary service is preparing a will by a lawyer. In a further example, the primary service is preparing a tax return by an accountant, and the secondary service is tax planning, tax shelter structuring, or a trust establishment by a lawyer. In a further example, the primary service is the arrangement of a funeral service, and the secondary service is the legal authorization for the handling of human remains. A person of skill in the art will now appreciate how these other examples can be implemented using the teachings herein. Further examples will now occur to those of skill in the art.

As another example, it is contemplated that the primary workflow can be implemented in the form of a single step that generates a general set of information regarding a given topic, and the secondary service can be a legal service pertaining to the given topic. To give a more specific example, the primary service can be part of an offering of an educational institution that is recruiting international students. Such a primary service can include a general information page on visa requirements for those international students, and the secondary service can be the preparation of a student visa application by an immigration lawyer.

It will now be apparent to a person of skill in the art that the present specification affords certain advantages over the prior art. For example, block 304 and method 300 can conserve a significant amount of network resources in network 104. Since client device 112 only needs to send the electronic request to server 108, it is no longer necessary for client device 112 to transmit the request to multiple platforms 120. Therefore, the process of requesting a quote according to the present disclosure is more resource efficient than prior art search systems.

Furthermore, in some prior art types of service requests may not been fully automated because they involve services from more than one service provider, information for which is managed on separate servers, thereby involving two separate searches from a client device 112 For example, the purchase of real estate can require both mortgage agreement process as a primary service and then the fulfillment of the mortgage agreement and fulfillment of the agreement of purchase and sale as legal services as a secondary service. Therefore, a service request for a real estate transaction cannot be fulfilled until a legal service provider has been retained. This issue contributes to wasted computing and networking resources when incomplete service requests are cancelled and resubmitted at a later date. System 100 and method 300 avoid this issue by combining the request for the primary and secondary services.

Additionally, system 100 and method 300 can improve the efficiency of parsing a plurality of secondary platforms 120 for a suitable service provider. By curating the number of options presented at client device 112, computing and networking resources can be conserved.

Further, storing client data and managing production workflows on server 108 improves the process of transferring responsibility of a file from one service provider to another. Since production data is stored at server 108, no network resources are expended to transfer client data from one secondary platform 120-1 to another secondary platform 120-2.

Moreover, the data records can be obtained from server 108 more quickly than if client device 112 were to send individual requests to a plurality of secondary platforms 120. Specifically, the period of time between receiving an electronic request at block 304 and transmitting the data records at block 320 may be shorter relative to the prior art methods. In some embodiments, client device 112 may receive data records representing quotes almost instantaneously. In other embodiments, client device 112 may receive data records representing quotes within seconds of sending a request. In contrast, the prior art methods may require several minutes, hours, or even days to deliver quotes from a plurality of service providers in response to a request.

Furthermore, system 100 can reduce the number of data transmissions between client device 112 and secondary platform 120. In the prior art systems, client device 112 would sometime send electronic requests that did not include all of the information required by secondary platform 120 to prepare a quote. This can necessitate a request for additional information from before secondary platform 120 could calculate a quote to transmit to client device 112. By prompting the client for inputs representing a predetermined list of questions, client device 112 can provide that all relevant information is transferred to server 108 in a single transmission. This can increase the speed of requesting and obtaining a quote and ultimate selection of a secondary platform 120.

Additionally, block 308 and 316a can conserve computing resources at secondary platform 120. Because the parameters are stored in non-volatile memory 212 at server 108, secondary platform 120 may only need to generate parameters once as opposed to generating parameters each time that a client requests a quote. Parameters stored in memory at server 108 can be updated periodically or as required. Moreover, the dynamic pricing performed at block 316a allows quotes to be generated automatically based on parameters stored in non-volatile memory 212, even for complex circumstances. This reduces the burden on computing resources at secondary platform 120.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

1. A method for managing data records representing quotes, the method comprising:
receiving an electronic request at a server from a client device via a primary platform;
retrieving secondary platform parameters stored in memory at the server, each secondary platform parameter associated with one of a plurality of secondary platforms;
retrieving a rating for each secondary platform parameter, the ratings stored in memory at the server; the ratings representing a quality of a match between a primary workflow respective to the primary platform and a secondary workflow that complements the primary workflow and which is hosted by each of the secondary platforms;
determining a subset of the secondary platforms based on the secondary platform parameters, the electronic request, and the ratings;
controlling the client device to generate the subset of the secondary platforms; and
receiving a selection response from the client device, the selection response corresponding to a selected one of the subset of secondary platforms.

2. The method of claim 1 further comprising updating the ratings based on the selection response.

3. The method of claim 1, wherein receiving the electronic request further comprises:
receiving primary request parameters;
controlling the client device based on the primary request parameters;
receiving secondary request parameters; and
controlling the client device based on the secondary request parameters.

4. The method of claim 1, wherein determining the subset of the secondary platforms further comprises:
generating a data record for each of the plurality of secondary platforms;
computing a competitiveness score based on at least one of: the respective secondary parameters, the respective ratings, and the respective data records; and
selecting the subset of secondary platforms based on the competitiveness score.

5. The method of claim 1 further comprising:
controlling the client device, the primary platform, and the selected secondary platform to implement an intake workflow; and
controlling the client device, the primary platform, and the selected secondary platform to implement a production workflow.

6. The method of claim 5 further comprising:
receiving a further selection response from the client device, the further selection response corresponding to another one of the plurality of secondary platforms; and
updating the intake and production workflows according to the further selection response.

7. The method of claim 4 further comprising:
updating the data records based on the competitiveness score.

8.-11. (canceled)

12. A system for managing data records representing quotes, the system comprising:
a server;
a client device configured to transmit an electronic request to the server via a primary platform; and
a plurality of secondary platforms configured to transmit secondary platform parameters to the server;
wherein the server is configured to:
receive the electronic request;
retrieve the secondary platform parameters from memory, each secondary platform parameter associated with one of a plurality of secondary platforms;
retrieve a rating for each secondary platform parameter, the ratings stored in memory at the server, the ratings representing a quality of a match between a primary workflow respective to the primary platform and a secondary workflow that complements the primary workflow, and which is hosted by each of the secondary platforms;
determine a subset of the secondary platforms based on the secondary platform parameters, the electronic request, and the ratings;
control the client device to generate the subset of the secondary platforms based on the ratings; and
receive a selection response from the client device, the selection response corresponding to a selected one of the subset of secondary platforms.

13. The system of claim 12 wherein the server is further configured to update the ratings based on the selection response.

14. The system of claim 12 wherein the server is further configured to:
receive primary request parameters from the client device;
controlling the client device based on the primary request parameters;
receive secondary request parameters from the client device; and
control the client device based on the secondary request parameters.

15. The system of claim 12, wherein the server is further configured to:
generate a data record for each of the plurality of secondary platforms;
compute a competitiveness score based on at least one of: the respective secondary parameters, the respective ratings, and the respective data records; and
select the subset of secondary platforms based on the competitiveness score.

16. The system of claim 12 wherein the server is further configured to:
control the client device, the primary platform, and the selected secondary platform to implement an intake workflow; and
control the client device, the primary platform, and the selected secondary platform to implement a production workflow.

17. The system of claim 16 wherein the client device is further configured to transmit a further selection response to the server, the further selection response corresponding to another one of the plurality of secondary platforms; and
the server is further configured to update the intake and production workflows in response to receiving the further selection response.

18. The system of claim 15 wherein the server is further configured to update the data records based on the competitiveness score.

19.-22. (canceled)

23. A non-transitory computer readable medium comprising instructions for managing data records representing quotes, the instructions for:
receiving an electronic request at a server from a client device via a primary platform;
retrieving secondary platform parameters stored in memory at the server, each secondary platform parameter associated with one of a plurality of secondary platforms;
retrieving a rating for each secondary platform parameter, the ratings stored in memory at the server, the ratings representing a quality of a match between a primary workflow respective to the primary platform and a secondary workflow that complements the primary workflow, and which is hosted by each of the secondary platforms;
determining a subset of the secondary platforms based on the secondary platform parameters, the electronic request, and the ratings;
controlling the client device to generate the subset of secondary platforms; and
receiving a selection response from the client device, the selection response corresponding to a selected one of the subset of secondary platforms.

24. The non-transitory computer readable medium of claim 23 further comprising instructions for updating the ratings based on the selection response.

25. The non-transitory computer readable medium of claim 24, wherein receiving the electronic request further comprises:
receiving primary request parameters;
controlling the client device based on the primary request parameters;
receiving secondary request parameters; and
controlling the client device based on the secondary request parameters.

26. The non-transitory computer readable medium of claim 23, wherein determining the subset of the secondary platforms further comprises:
generating a data record for each of the plurality of secondary platforms;
computing a competitiveness score based on at least one of: the respective secondary parameters, the respective ratings, and the respective data records; and
selecting the subset of secondary platforms based on the competitiveness score.

27. The non-transitory computer readable medium of claim 23 further comprising instructions for:
controlling the client device, the primary platform, and the selected secondary platform to implement an intake workflow; and
controlling the client device, the primary platform, and the selected secondary platform to implement a production workflow.

28. The non-transitory computer readable medium of claim 27 further comprising instructions for:
receiving a further selection response from the client device, the further selection response corresponding to another one of the plurality of secondary platforms; and
updating the intake and production workflows according to the further selection response.

29. The non-transitory computer readable medium of claim 26 further comprising instructions for updating the data records based on the competitiveness score.

30.-33. (canceled)
